(19) United States
(12) Patent Application Publication
(10) Pub. No.: US 2012/0241274 A1
(43) Pub. Date: Sep. 27, 2012

(54) TWO-WAY OR DOG CLUTCH AND SELECTABLE ONE-WAY CLUTCH USING TILTED OR ANGLED SPRAGS

(75) Inventor: ROBERT HUGH FRANCIS LLOYD, Los Altos, CA (US)

(73) Assignee: LLOYDCO LLC, Los Altos, CA (US)

(21) Appl. No.: 13/071,502

(22) Filed: Mar. 25, 2011

(51) Int. Cl. F16D 41/07; F16D 15/00

(52) U.S. Cl. 192/32; 192/47

(57) ABSTRACT

This invention describes two types of mechanical clutches; a selectable one-way clutch and a two-way or dog clutch. Both clutches are constructed with sprags mounted on an axis that is tilted with respect to the axis of the shafts being connected by the clutches. Both engagement faces of the clutch are conical and parallel such that the clutches can be disengaged by withdrawing one of the clutch plates along the line of the shafts being connected. Sprags produce a one-way clutch. In the dog clutch, alternate sprags are mounted opposite to its neighbor, so the clutch is prevented from slipping in either direction.

This invention describes two types of mechanical clutches; a selectable one-way clutch and a two-way or dog clutch. Both clutches are constructed with sprags mounted on an axis that is tilted with respect to the axis of the shafts being connected by the clutches. Both engagement faces of the clutch are conical and parallel such that the clutches can be disengaged by withdrawing one of the clutch plates along the line of the shafts being connected. Sprags produce a one-way clutch. In the dog clutch, alternate sprags are mounted opposite to its neighbor, so the clutch is prevented from slipping in either direction.

### BACKGROUND OF THE INVENTION

Sprag are pieces—usually metal—that are mounted between the opposing surfaces of a clutch and are shaped such they jam when side A of the clutch starts to rotate faster than side B however allow free movement when the opposite is true. Their advantages include high torque capability and simplicity of construction and operation. To make them selectable requires a means of moving each sprag so it doesn't engage. To accomplish this while both sides of the clutch are moving, requires an elaborate mechanical structure. This invention describes a simpler way to do this.

Previous dog clutch designs involve the meshing of teeth on both sides of the clutch. One disadvantage of this is that it requires precise alignment prior to engagement and another is that it has to be at least as wide as twice the length of the engaging surface of the teeth. This invention describes a one-way clutch that can be engaged and disengaged while both sides of the clutch are moving with a means that requires little additional width and a dog clutch that doesn't require precise alignment prior to engagement and can be very thin or have a small outside diameter.

### OBJECTS OF THE INVENTION It is an object of this invention to produce a one-way clutch and a dog clutch than can be selected and de-selected while both sides of the clutch are rotating.

It is an object of this invention to produce a one-way clutch and a dog clutch than can be disengaged while under load.

It is an object of this invention to produce a selectable one-way clutch and a dog clutch that can be very thin.

It is an object of this invention to produce a selectable one-way clutch and a dog clutch than can have a very small diameter with high torque capability and not an excessive width (i.e. length along the axis of the shafts).

It is an object of this invention to produce a selectable one-way clutch and a dog clutch that would be low-cost.

It is an object of this invention to produce a selectable one-way clutch and a dog clutch that can be designed such that the force required to engage and disengage them can be changed and can be very small.

It is an object of this invention to produce a dog clutch that doesn't require precise alignment prior to engagement.

It is an object of this invention to produce a dog clutch that will have small or no backlash.

### SUMMARY OF THE INVENTION

This invention describes a modification of a standard sprag clutch such that it can be disengaged by Withdrawing one side of the clutch from the other. This is accomplished by arranging for the parallel contacting surfaces to be tilted in respect to the axis of shafts being connected by the clutch. A further claim of the invention involves every other sprag being oriented such that it locks up in the opposite direction such that when engaged, the shafts are locked in both directions thus producing a dog or two-way clutch. Since existing dog clutches involve the meshing of two sets of teeth, they require precise alignment prior to engaging and need to be unloaded prior to disengagement. This invention results in a dog clutch that doesn't require precise alignment and can be disengaged under load. The force required to disengage the clutch can be changed by changing the angle of the parallel conical surfaces with respect to the axis of the shafts. Another feature of the dog clutch and the one-way clutch is that they can be disengaged with a very small change in the separation of the two sides. This results in a thin clutch. The dog clutch has little or no backlash.

### BRIEF DESCRIPTION OF THE DRAWINGS

FIG. 1 is a sectioned view of the one-way clutch.

FIG. 2 illustrates the sprag arrangement required to produce the dog clutch.

FIG. 3 illustrates a version of the one-way and dog clutch that has a small outside diameter and can handle high torque.

### DETAILED DESCRIPTION OF THE INVENTION

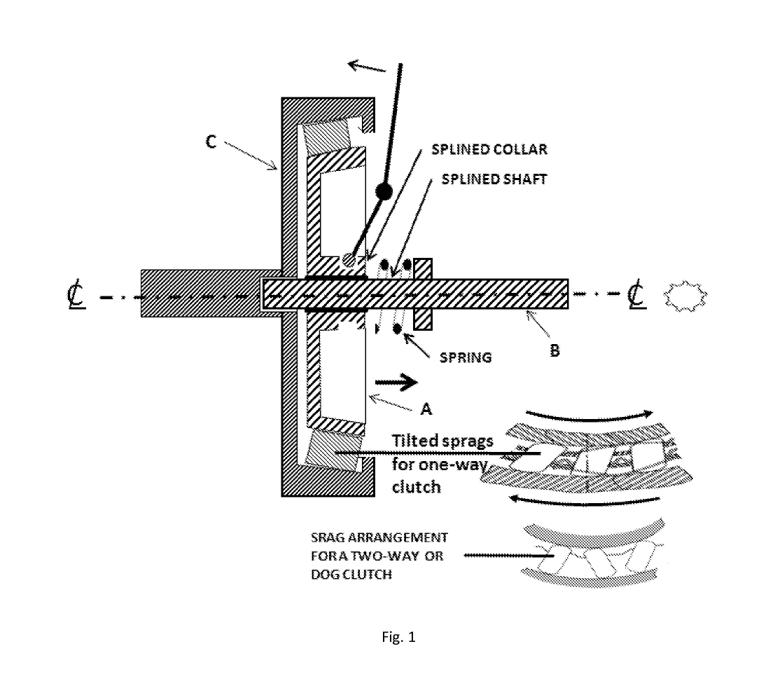

Part C in FIG. 1 is cylindrical in shape and attached to one of the shafts to be coupled by the clutch. The inside surface—i.e. engaging surface—of the cylinder is shaped as a section of a cone. Part A is similarly cylindrical whose outside surface is parallel to the conical inside surface of part C. The sprags represent the connection between these two surfaces and allow free motion in the directions shown for the one-way clutch and allow no relative circular motion for the dog clutch. Part A is attached to shaft B with a splined joint that allows part A to move along shaft B. The spring holds the clutch in the engaged position without contributing any friction forces to the clutch. The clutch is disengaged while rotating with the lever shown. The use of sprags allows the clutch to be engaged without precise alignment. The force required to disengage the clutch under load is determined by the angle of the engagement surfaces on parts A and C with respect to the center lines of the shafts to be coupled and whether or not the clutch surfaces are lubricated.

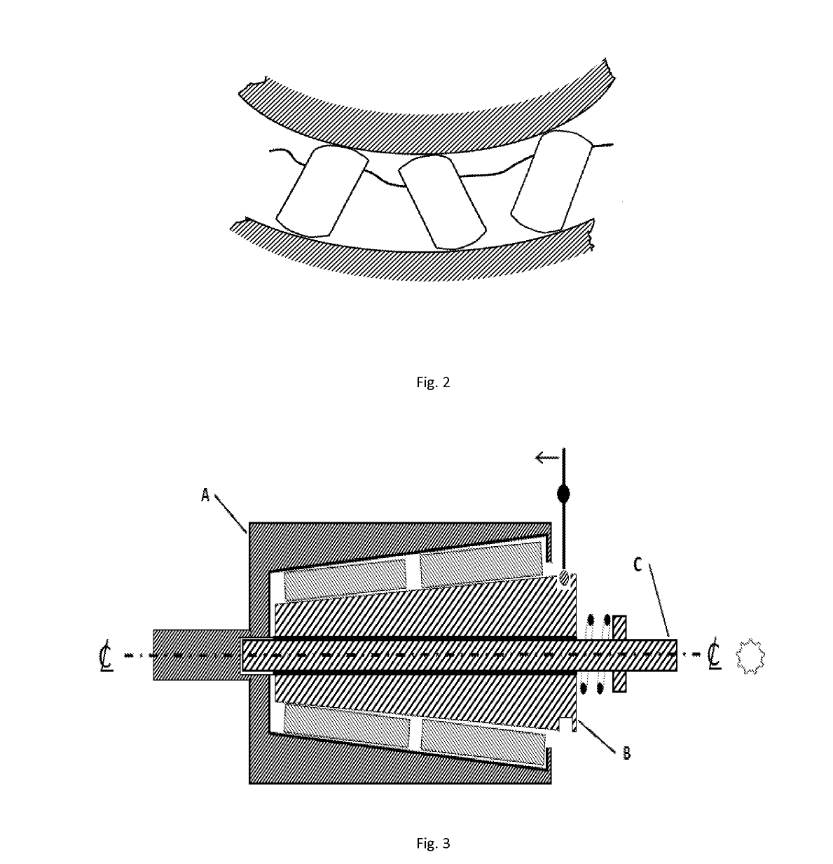

FIG. 2 illustrates the arrangement of the sprags as shown in FIG. 1 necessary to produce a dog or two-way clutch. The sprags are arranged so as to prevent relative motion in either direction. Both clutches can be designed either with a large outer diameter and small width along the direction of the shafts or with small diameter and a large width (FIG. 3). The advantage of the latter is that little additional width is required to accommodate the engagement and disengagement motion. Both can be designed to handle a large amount of torque.

What is claimed is:

1. A mechanical shaft-coupling clutch comprising:
A, a cylindrical piece attached on one of the shafts where one end of the cylinder is closed and attached to the shaft and the other end of the cylinder is open and where the inside surface of the circumference of the cylinder is a section of a cone where the apex of the cone is in the direction of the closed end of the cylinder;
B, A cylindrical shaped piece attached to the other shaft thru a splined joint which allows the cylinder to move toward and away from the first cylindrical piece and having the surface of the outer periphery parallel to the conical inside surface of the cylindrical piece on the other shaft;
C, An assemble of sprags mounted to either of the above pieces and placed such that it forms a connection between the conical surfaces and arranged so as to allow rotation of one of the surfaces to be faster than the other and prevent that surface from rotating slower than the other;
D, and a means to move the above pieces toward or away from each other while they are revolving;
E, and a means to assure that both cylindrical pieces cannot rotate independently of the shafts supporting them.

2. The clutch of claim 1 except the sprags are arranged such that when in contact, the cylindrical pieces are locked together and prevented for rotating independently of each other in either direction.

3. The clutch of claim 1 wherein two or more sprags are arranged side by side in a direction parallel to the engaging surfaces of the two cylindrical clutch plates.

4. The structure of claims 1 and 2 wherein the parts are manufactured such that the angle between the parallel engaging surfaces of both parts and the axis of the shafts is changed so as to change the force required to engage and disengage the clutch.
